(19) United States
(12) Patent Application Publication
(10) Pub. No.: US 2004/0267955 A1
(43) Pub. Date: Dec. 30, 2004

(54) System and method for network communication

(75) Inventors: David Konetski, Austin, TX (US); Chad P. Roesle, Austin, TX (US)

Correspondence Address: Roger Fulghum, Baker Botts L.L.P., One Shell Plaza, 910 Louisiana Street, Houston, TX, 77002-4995, US

(73) Assignee: DELL PRODUCTS L.P.

(21) Appl. No.: 10/609,051

(22) Filed: Jun. 27, 2003

(51) Int. Cl. G06F 15/16

(52) U.S. Cl. 709/231

(57) ABSTRACT

A communications network is disclosed in which a data processing system combines multiple instances of digital data into a single combined data stream. The combined data stream is provided to a thin media client, which renders the data stream for display or playback. The pre-processing tasks associated with combining multiple instances of digital data into a single data stream are performed at the data processing system and not at any of the thin media clients. Sources of digital data for the communications network may include stored digital content accessible by the network, Internet content, or digital communications from household appliances.

### TECHNICAL FIELD

The present disclosure relates generally to the field of communication networks, and, more particularly, to a system and method for providing data streams to thin media clients.

### BACKGROUND

As the value and use of information continues to increase, individuals and businesses seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems include thin media clients. A thin client is often considered to be a computer terminal that performs little or no application processing at the terminal. Instead, processing functions and data storage functions are performed at a central server. In the case of a thin media client, the thin media client likewise performs few data processing or storage functions. Rather, a thin media client performs the functions of playing or displaying the audio and visual outputs of the thin media client, while leveraging the processing and storage capabilities of a central server or computing system. Although a thin media client will perform few data processing functions, the thin media client may and typically will perform the functions of buffering and rendering the media.

Thin media clients are becoming more prevalent in homes and businesses. One example of a thin media client is a Turtle Beach Audio Tron™, which is a digital audio receiver that can be connected to a personal computer system as part of a home network. Another example of a thin media client would be a digital video receiver that receives a digital video stream and renders the audio and video data of the digital video stream to an associated television. The ability of a computer system to work in conjunction with a thin media client is described in U.S. application Ser. No. 09/771,095, filed Jan. 26, 2001, and titled “System and Method for Using Resources of a Computer System in Conjunction with a Thin Media Client,” which is incorporated herein by reference. !

As more and different types of thin media clients are included in a single home or business network, more opportunities will be created on the network for sharing of information or media among the clients or nodes of the network. The sharing of media streams among nodes of the network, however, would necessitate the mixing of multiple streams of data, resulting in processing obligations for the thin media clients of the network that are significantly greater than the processing capabilities required for simply rendering media streams. If additional processing capability were included in a thin media client for sake of handling the mixing of media streams, the cost of a typical thin media client with such processing capability would be prohibitive, as more processing power and memory is included within the thin media client.

### SUMMARY

In accordance with the present disclosure, a method and system is provided for providing data communications to thin media clients. The communications network of the present disclosure includes at least one source of digital data, one or more thin media clients, and a data processing device. The data processing device, which may comprise a computer system or any other suitable information handling device, performs the pre-processing functions necessary to combine two or more instances of digital content into a combined digital data stream that is provided to a thin media client. The thin media client renders the combined digital data stream for display or playback. The communications network may also include a hub device for routing communications between the nodes of the network. The sources of digital data may include the Internet, storage associated with the data processing system, a video camera, or a household appliance.

One technical advantage of the present disclosure is that the thin media client is not involved in the pre-processing of the data stream. The thin media client is responsible for the rendering of the media, but is not responsible for any of the pre-processing tasks related to the data stream, including the mixing, demultiplexing, or encoding of the data. The thin media client renders a data stream that comprises a media stream that has been previously pre-processed, and typically involves the combination of discrete instances of digital data, such as independent digital video streams, into a combined stream of digital data. Because the thin media client is not involved in the pre-processing of the data, the thin media client can render a digital video data stream in picture-in-picture or shared picture format without reference to the picture-in-picture or shared picture format of the digital video data stream.

Another technical advantage of the present disclosure is that the communications network may comprise a household communications network that includes household appliances. These household appliances may transmit digital communications to the network that are combined with our data streams to form a combined data stream that is transmitted to a thin media client. Another technical advantage of the present disclosure is a communications network allows for the efficient allocation of bandwidth among the communications paths of the network. Because the thin media clients may be optimized to receive a single combined data stream according to only a single predetermined format, the communications link between the hub device need not be configured with sufficient capacity to handle multiple data streams having any of a number of formats. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a communications network;

FIG. 2 is a diagram of a communications network; and

FIG. 3 is a flow diagram of the steps of transmitting and processing data in a communications network.

### DETAILED DESCRIPTION

The present disclosure concerns a system and method for providing pre-processed media stream to thin media clients. Disclosed herein is a network that includes at least one networked computer system or information handling system that performs the pre-processing tasks. The pre-processed data streams are transmitted to thin media clients for rendering. Because the pre-processing tasks, including the mixing of data streams, are not performed at the thin media client, the design of the thin media client may be optimized so that it is limited to performing the task of rendering design in a specific, predetermined format. From a network perspective, a single stream of data is provided to each thin media client, thereby reducing the amount of data that would otherwise be transferred to each thin media client if each thin media client performed local pre-processing.

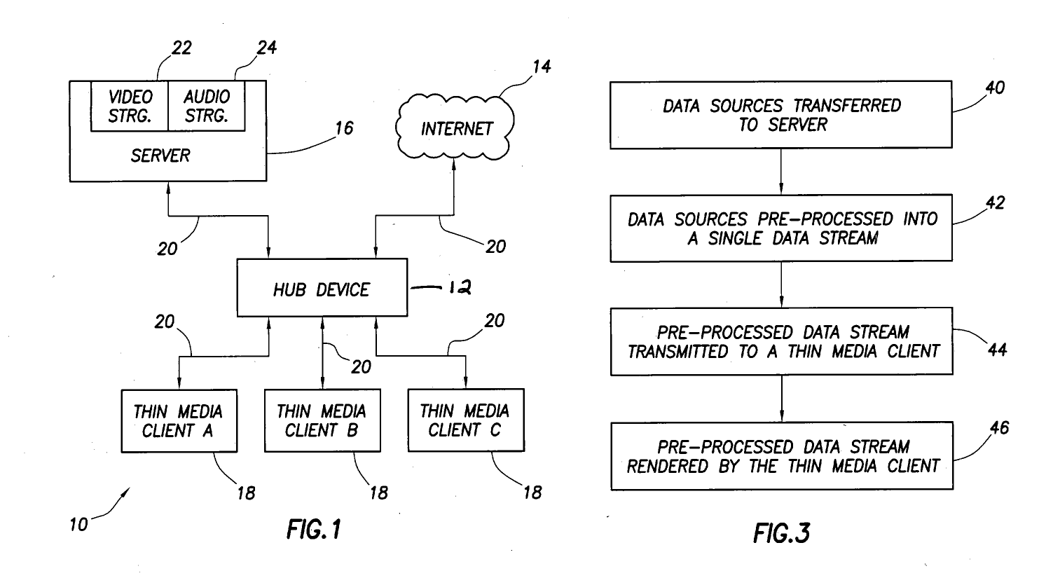

Shown in FIG. 1 is a communications network, which is indicated generally at 10. Communications network 10 may be a home network or a business network. Communications network 10 includes a hub device 12, which is coupled via a communications-link 20 to one of several thin media clients. In the example of FIG. 1, the thin media clients 18 are identified as Thin Media Client A, Thin Media Client B, and Thin Media Client C. Also coupled to hub device 12 is homer server 16. Server 16 is a computer system or other information handling system that performs pre-processing tasks on the data streams of the communications network. Server 16 includes video storage 22 and audio storage 24. The pre-processing tasks performed by the home server include the decoding, encoding, decryption, encryption, mixing, demultiplexing, attenuation, and amplification of data streams transmitted between the elements of the computer network. The data streams of communications network 10 may come from one of several sources, including the Internet 14 and storage areas on server 16, including video storage 22 and audio storage 24. The Internet node 14 will typically include a physical connection to the Internet as well as Internet browser software. Each of the thin media clients 18 does not perform the pre-processing or storage tasks of server 16. Rather, the thin media clients 18 perform the task of rendering the data stream provided from server 16 through hub device 12. As an example, a thin media client may be a rendering device that is associated with or incorporated into a display or playback device such as a television or digital audio receiver.

In operation, a user of communications network 10 may request a video display that consists of a live video stream that is layered in a picture-in-picture format with other prerecorded videos. The user may additionally request a video display that consists of a number of individual video streams arranged on a display device in a shared picture format, as in the case of four video streams, each of which is displayed in full in one quadrant of the display screen. The live or real-time video stream may be provided through the Internet node 14 and the prerecorded videos may be provided through the storage provided at server 16 or some other storage location associated with communications network 10. The communication of such a request may travel from a user associated with a thin media client, such as Thin Media Client A, to hub device 12. Hub device 12 will then route the request for the live or real-time video stream to Internet node 14 and will route the request for the prerecorded video stream to server 16.

Once the request for the real-time video stream is received at the Internet node 14, the real-time video feed is provided to server 16. Server 16 next pre-processes the requested signals. In this example, the requested signals—the live video stream and the prerecorded video stored locally at server 16—are mixed into a single digital data stream into a predetermined display format, such as a picture-in-picture or shared picture format. The single digital data stream is transmitted through hub 12 to the thin media client associated with the user's request. In this example, the single digital data stream is provided to Thin Media Client A, which renders the digital data stream for display on an associated display device, such as a television. The digital stream that is provided to Thin Media Client A does not need additional processing at Thin Media Client A to process the digital stream for display in a picture-in-picture or shared picture format. Rather, the digital data stream has been previously pre-processed by server 16 so that the digital-data stream is in a picture-in-picture or shared picture format as the display is delivered to Thin Media Client A. Because the pre-processing tasks are performed by server 16, each of the thin media clients 18 need not include the processing and storage capability necessary for the mixing of separate digital video data streams into a single digital data stream in a picture-in-picture or shared picture format.

As another example of the operation of the communications network 10 of FIG. 1, the user may request a presentation at Thin Media Client A that is a combination of a live video stream and a live audio stream. The user may, for example, want to watch a live sporting event while at the same time listening to a separate audio broadcast of the sporting event that is not associated with the video broadcast of the sporting event. The request for the real-time video stream and the real-time audio stream are transferred through hub 12 to a source, which in the example of FIG. 1 is the Internet node 14. It should be appreciated that live video and audio feeds may be available from content sources other than the Internet, such as satellite-based sources of live digital video and digital audio feeds. The live video and audio fees are provided to server 16 through hub 12. At server 16, pre-processing occurs on the digital video stream and the digital audio stream. The audio content of the digital video stream is fully attenuated from the digital video stream, and the result is mixed with the digital audio stream to produce a digital data stream that is then transmitted to the requesting Thin Media Client A through hub 12. At Thin Media Client A, the digital data stream is rendered for playback through an associated display or playback device. Thin Media Client A is not involved in the pre-processing of the digital streams. Instead, Thin Media Client A renders for display a digital data stream that has already been pre-processed according to the requests of the user. As discussed, the rendered data stream includes a video stream that has been overlaid with an audio stream.

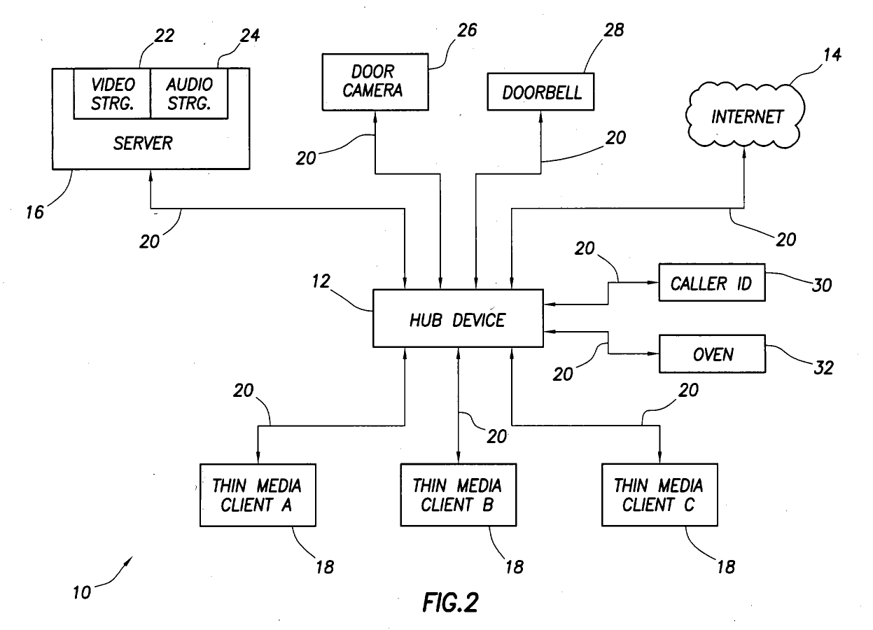

Shown in FIG. 2 is another example of communications network 10, which includes a hub 12 that is coupled through communication links 20 to an Internet node 14, server 16, and multiple thin media clients 18. As was the case with server of FIG. 1, the server of FIG. 16 includes digital video storage 22 and digital audio storage 24. Communications network 10 includes communications link 20 to other network devices that include door camera 26, doorbell 28, caller ID device 30, and oven 32. These devices are representative of in-home devices that are operable to send a digital signal to other devices in communications network 10. Door camera 10 can transmit a digital and audio signal in the form of either still images or a real-time video stream. Doorbell 28 can transmit a digital signal representing activity at a doorbell connected to network 10. Caller ID device 30 can transmit a digital signal representing caller activity to a telephone network including an identification of the calling telephone number and time of incoming calls. Oven 32 can transmit to network 10 a signal indicative of the status of a kitchen oven, including the temperature of the oven or the on/off status of the oven.

In the communications network of FIG. 2, data from one or more of the door camera 26, doorbell 28, caller ID device 30, and oven 32 can be layered over another data stream to provide to a user a notification concerning the status of an in-home digital device. As an example, a user may be watching a live digital video stream that is being accessed from Internet node 14. This real-time digital video stream may be pre-processed at server 16 and then rendered for display at Thin Media Client A. Hub 12 of communications network 10 may be configured such that a notification from any of doorbell 28, caller ID device 30, or oven 32 is overlaid in a picture-in-picture format on the real-time digital video stream. As an example, if the doorbell is pressed, a digital signal representing this event is transmitted from doorbell 28 to hub 12, which in turn routes the signal to server 16. Server 16 next mixes a signal representing the doorbell event with the real-time digital video stream. The mixed signal may be a graphic with the notation “DOORBELL” overlaid on the digital video stream in a picture-in-picture format. The mixing of the digital graphic and the real-time digital video stream is performed by server 16, leaving Thin Media Client A with the task of rendering the previously mixed digital video stream and displaying the rendered video for a user at an associated display device. A similar graphical overlay may be mixed in with a real-time digital video stream and transmitted to a thin media client in the case of data transmitted to the hub from caller ID device 30 (name, calling number and time of call) and oven (temperature and on/off status). It should be recognized that the digital video stream and the graphic can be displayed in shared picture format.

As another example, a user associated with a thin media client may request that the signal from a door camera 26 be provided in a picture-in-picture or shared picture format with another digital data stream, including, as just one example, a real-time digital video stream from Internet node 14. In this example, the data stream from door camera 26 is mixed with the real-time digital video stream at server 16. The mixed video stream is then transmitted to a thin media client for rendering and display. In addition to mixing the data streams, server 16 could also attenuate the audio portion of the real-time video stream from Internet node so that the audio portion of the data stream from door camera 26 can be more easily heard by the user. As another alternative, the two unique digital audio streams could be mixed together for playback to the user. Specifically, the user could be listening through a playback device to a digital audio stream being provided from the Internet. When a signal from an appliance or other network device is received at hub 12, the digital audio stream from the Internet may be attenuated for the sake combining the audio stream from the appliance, such as a doorbell chime, with the existing audio stream from the Internet.

A flow diagram depicting the steps of processing and transmitting data in the communications network 10 of FIG. 3. At step 40, data sources are transferred to server 16. As discussed, herein these data may comprise video or audio data sources, and the selection of these data sources may be made by a use or according to an established program or protocol. At step 42, the data sources are pre-processed by the user into a single data stream. At step 44, the pre-processed data stream is transmitted to a thin media client, and, at step 46, the pre-processed data stream is rendered for display or playback by the thin media client.

A feature of the thin media client communication network disclosed herein is that the pre-processing of the data is performed in a computer system or an information handling system that is separate from the thin media clients, making it possible for the thin media clients to have limited processing capacity related only to the function of rendering the data stream provided to the thin media client. In addition, because each thin media client receives a data stream that has been pre-processed, the communication links to the thin media clients need not be sized to have a bandwidth to receive multiple data streams. Instead, the communications links to the thin media clients can be of a smaller bandwidth to receive only the single data stream to be rendered by the thin media client. Although the present disclosure has been described in detail, it should be understood that various changes, substitutions, and alterations can be made hereto without departing from the spirit and the scope of the invention as defined by the appended claims.

What is claimed is:

1. A communications network, comprising:
a thin media client;
a source of digital media content;
a data processing device operable to receive digital media content from the source for digital media content and to perform a pre-processing function on at least two instances of digital media content to produce a combined digital data stream that is transmitted to the thin media client; and
wherein the thin media client is operable to render the combined digital data stream received from the data processing device.

2. The communications network of claim 1, further comprising a hub device and wherein each of the thin media client, the source of digital media content, and the data processing device are coupled to the hub.

3. The communications network of claim 1, wherein the source of digital media content comprises the Internet.

4. The communications network of claim 3, wherein the source of digital media content comprises digital media content stored in storage associated with the data processing device.

5. The communications network of claim 1, wherein the pre-processing function performed by the data processing devices comprises the mixing of the at least two instances of digital video content into a picture-in-picture format.

6. The communications network of claim 1, wherein the pre-processing function performed by the data processing devices comprises the mixing of the at least two instances of digital video content into a shared picture format.

7. The communications network of claim 6, wherein the pre-processing function performed by the data processing devices comprises the overly of an audio stream over a digital video stream.

8. A method for providing media content to a user associated with a thin media client, comprising the steps of:
receiving from the user a request for media content, the media content requested by the user comprising at least two instances of media content;
retrieving the at least two instances of media content;
pre-processing the at least two instances of media content to create a combined data stream of digital media;
transmitting the combined data stream to the thin media client; and
rendering the combined data stream at the thin media client to provide the media content of the data stream to the user.

9. The method for providing media content to a user associated with a thin media client of claim 8, wherein the at least two instances of media content comprise at least two instances of digital video.

10. The method for providing media content to a user associated with a thin media client of claim 9, wherein the step of pre-processing comprises the step of combining the at least two instances of digital video into a combined data stream in picture-in-picture format.

11. The method for providing media content to a user associated with a thin media client of claim 8, wherein the at least two instances of media content comprise a digital video data stream having an audio component and an audio-only data stream.

12. The method for providing media content to a user associated with a thin media client of claim 11, wherein the step of pre-processing comprises the steps of:
attenuating the audio component from the digital video data stream; and
combining the resulting digital video data stream with the audio-only data stream.

13. The method for providing media content to a user associated with a thin media client of claim 8, wherein the step of retrieving the at least two instances of media content comprises the step of retrieving at least one instance of media content from the Internet.

14. The method for providing media content to a user associated with a thin media client of claim 8, wherein the step of retrieving the at least two instances of media content comprises the step of retrieving at least one instance of media content from a media storage device.

15. The method for providing media content to a user associated with a thin media client of claim 8, wherein the step of retrieving the at least two instances of media content comprises the step of retrieving at least one instance of media content from a home appliance.

16. The method for providing media content to a user associated with a thin media client of claim 8, wherein the step of retrieving the at least two instances of media content comprises the step of retrieving at least one instance of media content from a video camera.

17. The method for providing media content to a user associated with a thin media client of claim 10, wherein the source of at least one instance of the two instances of digital video is a video camera.

18. A communications network, comprising:
at least one source of digital data;
at least one thin media client, each of the thin media clients associated with a display or playback device;
a data processing device operable to receive and pre-process multiple instances of digital data following a request from a user associated with one of the thin media clients to produce a combined data stream that is provided to the thin media client for rendering at the thin media client; and
a hub device coupled to each of the sources of digital content, the thin media clients; and the data processing device, wherein the hub device is operable to route communications between the sources of digital data, the thin media clients, and the data processing device.

19. The communications network of claim 18, wherein the at least one source of digital data is the Internet.

20. The communications network of claim 18, wherein the at least one source of digital data is a household appliance.

21. The communications network of claim 18, wherein the at least one source of digital data is a video camera.

22. The communications network of claim 18, wherein the combined data stream comprises multiple instances of digital video that has been combined in a picture-in-picture format.

23. The communications network of claim 20, wherein the combined data stream comprises a digital video stream combined with an image or audio tone representing a signal from a household appliance.

24. The communications network of claim 20, wherein the combined data stream represents a digital video stream combined with an audio stream.

25. The communications network of claim 18, wherein the combined data stream represents two unique audio streams.
